(19) United States
(12) Patent Application Publication
(10) Pub. No.: US 2016/0253427 A1
(43) Pub. Date: Sep. 1, 2016

(54) Obtaining Search Results

(71) Applicant: Alibaba Group Holding Limited, Grand Cayman (KY)

(72) Inventor: Jingjing Shen, Hangzhou (CN)

(21) Appl. No.: 15/045,050

(22) Filed: Feb. 16, 2016

(30) Foreign Application Priority Data
Feb. 26, 2015 (CN) 201510088838.5

(51) Int. Cl. G06F 17/30; G06F 3/0482; G06F 3/0484; H04L 29/06

(52) U.S. Cl. CPC G06F 17/30867; G06F 17/30554; H04L 63/083; G06F 17/30598; G06F 3/0482; G06F 3/04842

(57) ABSTRACT

Methods and devices for obtaining search results. For example, a method may include receiving, by a computing device, search information input by a current user and a target user that is associated with the search information and designated by the current user. The computing device may transmit to a server terminal a search request including the search information and the target user such that the server terminal may obtain feature information of the target user based on the search information of the search request, obtain a search result corresponding to the feature information based on the search information, and return the search result to the client terminal, which may receive and display the search result. The implementations provide an approach for obtaining search results associated with a desired target user.

### CROSS REFERENCE TO RELATED PATENT APPLICATIONS

This application claims priority to Chinese Patent Application No. 201510088838.5, filed on Feb. 26, 2015, entitled “Methods and devices for obtaining search results,” which is hereby incorporated by reference in its entirety.

### TECHNICAL FIELD

Implementations herein relate to the field of computer technology, and more particularly to methods and systems for obtaining search results.

### BACKGROUND

With the continuous development of e-commerce, e-commerce websites are filled with information of vast amounts of commodities. To facilitate users to quickly access the information, e-commerce websites allow users to use search engines to find desired items.

In e-commerce websites, users may perform the following operations to search their desired items: accessing a search engine page, entering keywords and a query condition (e.g. category information, a price range, a type of service, a brand, etc.), and then clicking a search button. A corresponding server terminal may receive a search request, obtain personalized information of the users, and forward to a search engine the search request including the personalized information, the query condition and the keywords. The search engine may perform searches based on the search request to obtain information related to items that meet the search condition, and return the information to the server terminal. The server terminal may then process the information and present the processed information to the users.

Existing search engines can provide personalized search results to individual users, and each user can view the personalized search results. In some cases, a user does not need to obtain search results relevant to the user. For example, the user may want to buy a gift for a father of the user. Under conventional techniques, while the search engines may find personalized search results, these search results are not related to the father of the user. This results in poor user experience.

### SUMMARY

The purpose of the present disclosure is intended to solve at least one of the above-mentioned technical problems to some extent. Implementations herein relate to methods and devices for obtaining search results. The implementations further relate to methods for obtaining search results associated with a desired target user. This allows users to easily obtain personalized search results of other objects, to meet individual needs of the users, and to improve search experience of the users. This Summary is not intended to identify all key features or essential features of the claimed subject matter, nor is it intended to be used alone as an aid in determining the scope of the claimed subject matter.

Further, the implementations relate to a method for obtaining search results. The method for obtaining search results may include receiving, by a computing device (e.g., a client terminal), search information input by a current user and a target user that is associated with the search information and designated by the current user. The computing device may transmit to a server terminal a search request including the search information and the target user such that the server terminal may obtain feature information of the target user based on the search information of the search request, obtain a search result corresponding to the feature information based on the search information, and return the search result to the computing device. The computing device may receive and display the search result returned from the server terminal.

The implementations may include receiving search information input by a current user and a target user that is associated with the search information and designated by the current user, transmitting to a server terminal a search request including the search information and the target user such that the server terminal may obtain feature information of the target user based on the search information of the search request, obtain a search result corresponding to the feature information based on the search information, and return the search result to a client terminal. The search result then may be received and displayed by the client terminal.

Accordingly, the implementations provide an approach for obtaining search results associated with a desired target user. This allows users to easily obtain personalized search results of other objects, to meet individual needs of the users, and to improve search experience of the users.

Further, the implementations relate to another method for obtaining search results. The method for obtaining search results may include receiving, by a computing device (e.g., a server terminal), a search request from a client terminal. In these instances, the search request may include search information input by a current user and a target user that is associated with the search information and designated by the current user. The computing device may obtain feature information of the target user based on the search information of the search request, obtain a search result corresponding to the feature information based on the search information, and return the search result to the client terminal such that the client terminal receives and displays the search result.

The implementations for obtaining search results may include receiving from a client terminal search information input by a current user on the client terminal and a search request including a target user that is associated with the search information and designated by the current user. In these instances, a server terminal may obtain feature information of the target user based on the search information of the search request, obtain a search result corresponding to the feature information based on the search information, and return the search result to the client terminal such that the client terminal receives and displays the search result.

Accordingly, the implementations provide an approach for obtaining search results associated with a desired target user. This allows users to easily obtain personalized search results of other objects, to meet individual needs of the users, and to improve search experience of the users.

Further, the implementations relate to a device for obtaining search results. The device may include a processing module configured to receive search information input by a current user and a target user that is associated with the search information and designated by the current user, and transmit to a server terminal a search request including the search information and the target user. In these instances, the server terminal may obtain feature information of the target user based on the search information of the search request, obtain a search result corresponding to the feature information based on the search information, and return the search result to the device. The device may further include a displaying module configured to receive and display the search result returned from the server terminal.

The device may, via the processing module, receive search information input by a current user and a target user that is associated with the search information and designated by the current user. The device may transmit to a server terminal a search request including the search information and the target user such that the server terminal may obtain feature information of the target user based on the search information of the search request, obtain a search result corresponding to the feature information based on the search information, and return the search result to the device. Then, the displaying module of the device may receive and display the search result returned from the server terminal.

Accordingly, the implementations provide an approach for obtaining search results associated with a desired target user. This allows users to easily obtain personalized search results of other objects, to meet individual needs of the users, and to improve search experience of the users.

Further, the implementations relate to another device for obtaining search results. The device may include a receiving module configured to receive a search request from a client terminal. In these instances, the search request may include search information input by a current user and a target user that is associated with the search information and designated by the current user. The device may further include a processing module configured to obtain feature information of the target user based on the search information of the search request, obtain a search result corresponding to the feature information based on the search information, and return the search result to the client terminal such that the client terminal receives and displays the search result.

The device may, via the receiving module, receive from a client terminal search information input by a current user on the client terminal and a search request including a target user that is associated with the search information and designated by the current user. The processing module may obtain feature information of the target user based on the search information of the search request, obtain a search result corresponding to the feature information based on the search information, and return the search result to a client terminal such that the client terminal receives and displays the search result.

Accordingly, the implementations provide an approach for obtaining search results associated with a desired target user. This allows users to easily obtain personalized search results of other objects, to meet individual needs of the users, and to improve search experience of the users.

### BRIEF DESCRIPTION OF THE DRAWINGS

The Detailed Description is described with reference to the accompanying figures. The use of the same reference numbers in different figures indicates similar or identical items.

FIG. 1 is a flowchart depicting an example method for obtaining search results in accordance with an embodiment of the present disclosure.

FIG. 2 is a flowchart depicting another example method for obtaining search results in accordance with an embodiment of the present disclosure.

FIG. 3 is a diagram depicting an example device for obtaining search results in accordance with an embodiment of the present disclosure.

FIG. 4 is a diagram depicting another example device for obtaining search results in accordance with an embodiment of the present disclosure.

### DETAILED DESCRIPTION

Examples of the following detailed descriptions of the present disclosure may be illustrated using the accompanying drawings. Throughout, the same or similar reference numerals represent the same or similar elements or elements having the same or similar functions. The following examples with reference to the accompanying drawings are illustrative and are intended to explain the present disclosure, and may not be construed as limiting the present disclosure.

With reference to the accompanying drawings, it is described below examples of methods and devices for obtaining search results.

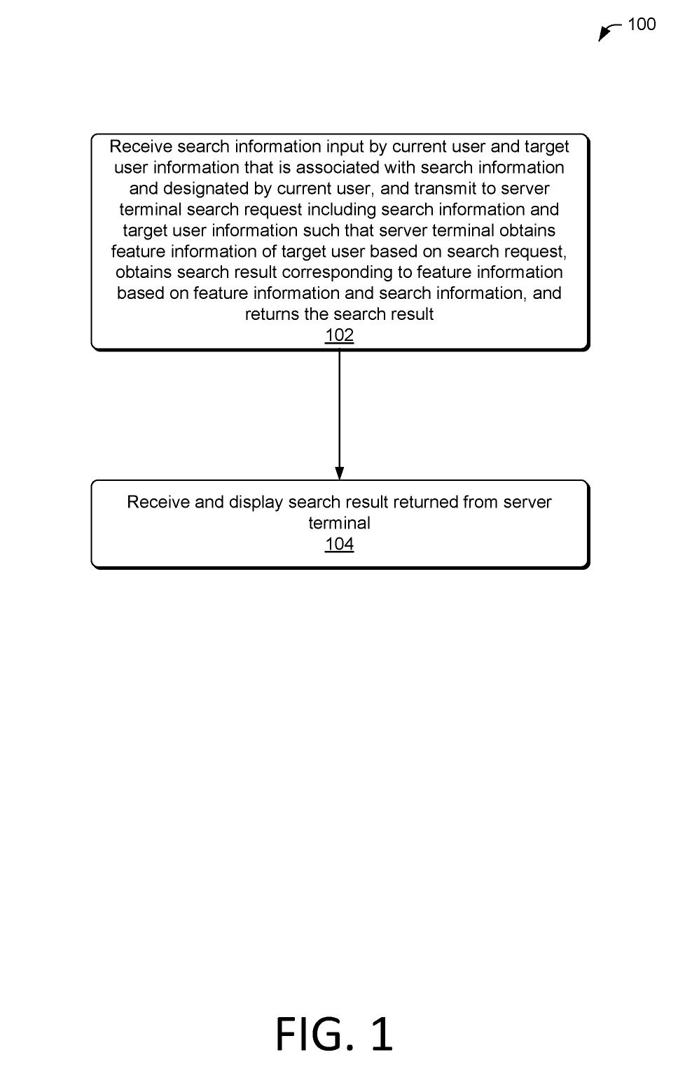

FIG. 1 is a flowchart depicting an example method for obtaining search results in accordance with an embodiment of the present disclosure. As illustrated in FIG. 1, the method may be implemented by a client terminal and include the following operations.

At 102, a computing device (e.g., a client terminal) may receive search information input by a current user and target user information that is associated with the search information and designated by the current user. The computing device may further transmit to a server terminal a search request including the search information and the target user information such that the server terminal may obtain feature information of the target user based on the search request. The server terminal may obtain a search result corresponding to the feature information and the search information and return the search result to the computing device.

In implementations, the search information may include a keyword input by users and a search condition selected by the user (e.g., a type of a search object, release time intervals of the search object, etc.). The target user information may be a target user ID or belong to a category of the target user. The feature information of the target user may include but is not limited to one of property information of the target user, behavior information of the target user, or preference information of the target user.

In implementations, the feature information of the target user may include, but is not limited to, a gender, an age, a location, and other information of the target user. Behavioral information and/or preference information of the target user may be obtained based on historical behavior of the target user that may be recorded in logs. When a search engine provides search services, the search engine may provide specific or personalized search results based on a user profile and/or may sort the search results based on the user profile.

In implementations, the search engine may push specific search results or adjust ranking of the search results based on feature information of the target user related to the search information that is specified by the current user.

In implementations, the client terminal may include a terminal, which may include a smart phone, a tablet computer, a personal computer (PC) with a variety of operating systems and other hardware devices. For example, the client terminal may include a smart phone application (e.g., shopping applications such as Taobao).

In implementations, the current user may use a search engine to perform searches. The current user may input a keyword and a search condition (e.g., a price range, a service type, a brand, etc.). If the current user does not want to use a current default identity with respect to a certain search, the current user may choose a desired identify for the certain search, namely, the target user as described in the implementations. In these instances, the client terminal may accept the choice of the current user.

Further, the client terminal may determine whether the desired identity (e.g., the target user) is another user (e.g., the target user) or another type of users. The client terminal may provide a corresponding processing strategy based on the determination.

In a scenario, in response to a determination that the desired identity (e.g., the target user) is the target user for the search, the current user may set the desired identify (e.g., the target user) for the search using the following ways.

In a first way, when the current interface displays an interface for inputting an account, the client terminal may receive an account ID of the target user that is input by the current user. The client terminal may transmit to the server terminal a permission query, and the server terminal may receive the permissions query such as to obtain a query permission of the current user from pre-stored user query permissions based on the permission query. If the query permission is a default permission, the server terminal may return a default command to the client terminal. The client terminal may receive the default command from the server terminal. Further, the client terminal may display the interface for inputting the password based on the received default command.

For example, different users have different query permissions. For an administrator, after the administrator successfully logs in the account management system, the administrator does not need to enter a password and may perform searches using various identifies or roles. This allows the administrator to review search results of a user after receiving feedback from the user. For an ordinary user, the ordinary user needs to be authorized by a certain user or obtain the account ID of the certain user when the ordinary user performs searches using an identify of the certain user.

When the current interface displays an interface for inputting a password, the client terminal may receive the password of the target user that is input by the current user. In response to a determination that the user clicks on a confirmation button on the current interface, the client terminal may send the account ID and the password to the server terminal. After the server terminal confirms that the password corresponds to the account ID, the server terminal may return to the client terminal a first instruction of successful acceptance of the target user.

The client terminal may receive the first instruction from the server terminal, and complete the selection of the target user based on the first instruction.

In a second way, when the current interface displays an interface for inputting an account, the client terminal may receive the account ID of the target user that is input by the current user and transmit to the server terminal the account ID of the target user. The server terminal may receive the account ID of the target user from the client terminal, and search a list of authorized users associated with the target user based on the account ID of the target user. If the list of authorized users includes the account ID of the current user, the server terminal may return a second instruction of successful acceptance of target user. The client terminal may receive the second instruction from the server terminal, and complete the selection of the target user based on the second instruction.

For example, current user A wants to use an identity of B to perform a search. To set a target user, the client terminal may display an interface for inputting an account ID on a current interface. User A inputs the account ID of user B, and the client terminal may receive the account ID of user B from user A. The client terminal may further transmit the account ID of user B to the server terminal.

The server terminal may receive the account ID of user B, and search a list of authorized users associated with user B based on the account ID of user B. Further, the server terminal may determine whether the list of authorized users includes an account ID of user A.

If the list of authorized users includes the account ID of user A, the server terminal may return to the client terminal a confirmation instruction. The client terminal accepts the identity selected by user A in accordance with the confirmation instruction, namely, user A uses the identity of B to perform a search. If the list of authorized users does not include the account ID of user A, the server terminal may return a refusal instruction to the client terminal. After the client terminal receives the refusal instruction, the client terminal may reject user A to use the identity of user B to perform the search. The client terminal may display a corresponding message on the interface to notify user A.

In another scenario, in response to a determination that the target user selected by the current user associated with the client terminal for the search is a certain type of users, the client terminal may transmit a category search request of the current user to the server terminal. The server terminal may receive the category search request of the current user and obtain a pre-stored category list of different categories of users based on the category search request. The client terminal may receive the category list from the client terminal and display the category list on the current interface.

In implementations, the server terminal may analyze information of various users to obtain the category list. For example, the users may be classified as “high handsome rich”, “white rich beauty,” “successful man”, “affordable Housewives” and other categories based on the history of users' gender, age, purchasing power and other information. Table 1 illustrates exemplary personalized information of “high handsome rich”.

TABLE 1

| category | gender | age | Purchasing power |
|---|---|---|---|
| High rich | male | 20-30 | High |
| handsome | | | |

When the target user belongs to the category of the target user, the client terminal may receive the category of the target user that is selected by the current user from the category list of the different users that is displayed by the current interface. After the client terminal transmits the search request including the keyword, the search condition, and the target user to the server terminal, the server terminal may receive the search request accordingly. The sever terminal may obtain the feature information of the target user based on the search request, and obtain search results corresponding to the feature information and the search information of the target user.

For example, after the server terminal receives the search request including the keyword, the search condition, and the target user information, the server terminal may obtain the feature information of the target user based on the search request. Suppose that the feature information of the target user (e.g., personalized information of users) includes: female, 20-30 years old, ordinary purchasing power, intending to purchase food and clothing, a corresponding IP address (Internet Protocol Address) indicating Hainan province.

Suppose that the keyword input by the current user is a woman's dress. The server terminal may perform searches based on the feature information of the target user and the keyword to obtain item information of the woman's dress fitting for a current time in Hainan province. The server terminal may return the item information to the client terminal. Accordingly, this allows users to easily obtain and to view personalized search results of the target user.

At 104, the computing device may receive and display the search result returned from the server terminal.

The implementations for obtaining search results may include receiving search information input by a current user and target user information that is associated with the search information and designated by the current user, and transmitting to a server terminal a search request including the search information and the target user information. Accordingly, the server terminal may obtain feature information of the target user based on the search request, obtain a search result corresponding to the feature information and the search information, and return the search result to the client terminal. The implementations further include receiving and displaying the search result returned from the server terminal.

Accordingly, the implementations provide an approach for obtaining search results associated with a desired target user. This allows users to easily obtain personalized search results of other users, to meet individual needs of the users, and to improve search experience of the users.

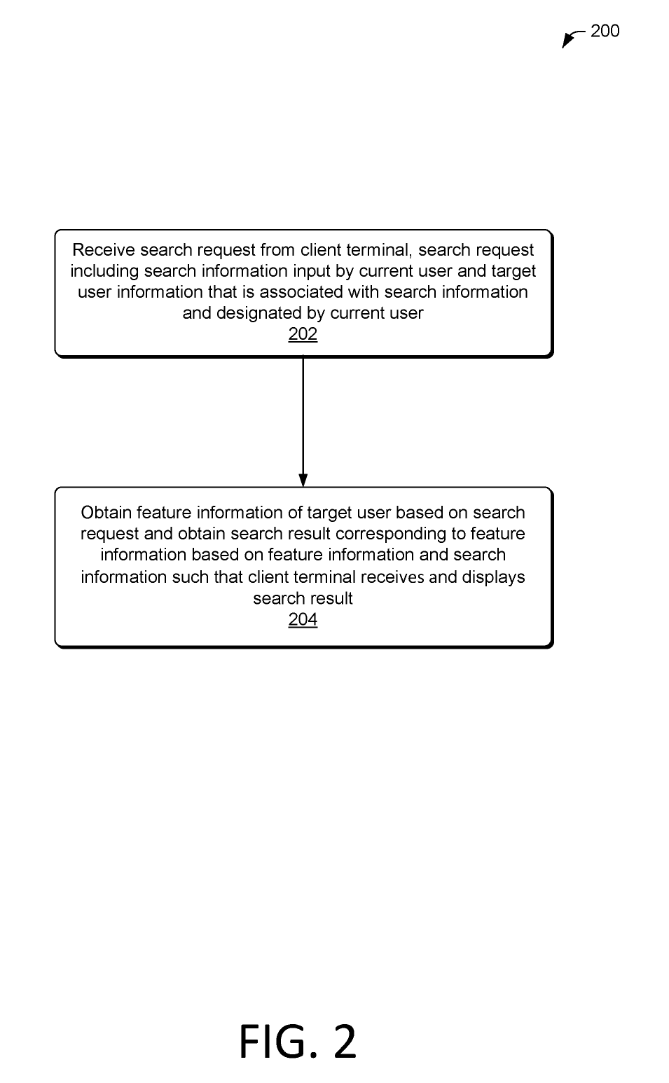

FIG. 2 is a flowchart depicting another example method for obtaining search results in accordance with an embodiment of the present disclosure. As illustrated in FIG. 2, the method may be implemented by a server terminal. The method may include the following operations.

At 202, a computing device (e.g., a server terminal) may receive a search request from a client terminal. In these instances, the search request may include search information input by a current user and a target user information that is associated with the search information and designated by the current user, and the search information may include a keyword input by users and a search condition selected by the user (e.g., a type of a search object, release time intervals of the search object, etc.). The target user information may be a target user ID or belong to a category of the target user.

In implementations, the client terminal may include a terminal, which may include a smart phone, a tablet computer, a personal computer (PC) with a variety of operating systems and other hardware devices. For example, the client terminal may include a smart phone application (e.g., shopping applications such as Taobao).

In implementations, prior to the receiving the search request from the client terminal, the server terminal may receive from the client terminal the account ID of the target user and the password associated with the account ID. In response to a determination that the password is correct, the server terminal may return to the client terminal a first instruction of successful acceptance of the target user such that the client terminal may accept the target user based on the first instruction.

In implementations, the client terminal may display an interface for inputting an account on the current interface. The client terminal may receive the account ID of the target user that is input by the current user, and may transmit to the server terminal a permission query. The server terminal may receive the permissions query such as to obtain a query permission of the current user from pre-stored user query permissions based on the permission query. If the query permission is a default permission, the server terminal may return a default command to a client terminal. The client terminal may receive the default command from the server terminal.

Further, the client terminal may display the interface for inputting the password based on the received default command. After receiving the password input by the current user, the client terminal may send the account ID and password to the server terminal. After the server terminal confirms that the password corresponds to the account ID, the server terminal may return to the client terminal a first instruction of successful acceptance of the target user. The client terminal may receive the first instruction from the server terminal, and complete the selection of the target user based on the first instruction.

For example, different users have different query permissions. For an administrator, after the administrator successfully logs in the account management system, the administrator does not need to enter a password and may perform searches using various identifies or roles. For ordinary users, an ordinary user needs to be authorized by a certain user or obtain the account ID of the certain user when the ordinary user may perform searches using an identify of the certain user.

Further, prior to the receiving the search request from the client terminal, the server terminal may receive the account ID of the target user and the password associated with the account ID such that the server terminal may search and obtain a list of authorized users associated with the target user based on the account ID of the target user. If the list of authorized users includes the account ID of the current user, the server terminal may return a second instruction of successful acceptance of target user to allow the client terminal to accept the target user based on the second instruction.

For example, current user A wants to use an identity of B to perform a search. To set a target user, the client terminal displays an interface for inputting an account ID on a current interface. User A inputs the account ID of user B, the client terminal may receive the account ID of user B from user A. The client terminal may transmit the account ID of user B to the server terminal, which may receive the account ID of user B and search a list of authorized users associated with user B based on the account ID of user B. Further, the server terminal may determine whether the list of authorized users includes an account ID of user A. If the list of authorized users includes the account ID of user A, the server terminal may return to the client terminal a confirmation instruction. After the client terminal receives the confirmation instruction, the client terminal may allow user A to user the identity of user B to perform the search.

If the list of authorized users does not include the account ID of user A, the server terminal may return a refusal instruction to the client terminal. After the client terminal receives the refusal instruction, the client terminal may reject user A to use the identity of user B to perform the search. The client terminal may display a corresponding message on the interface to notify user A.

In implementations, when the target user belongs to the category of the target user, prior to the receiving the search request from the client terminal, the server terminal may obtain a category list of different categories of users based on historic records. The server terminal may return to the client terminal the category list to allow the client terminal to display the category list and to allow the current user to select the category of the target user from the category list of different users.

In implementations, the server terminal may analyze information of various users to obtain the category list. For example, users may be classified as “high handsome rich”, “white rich beauty,” “successful man”, “affordable Housewives” and other categories based on the history of users' gender, age, purchasing power and other information. Table 1 illustrates exemplary personalized information of “high handsome rich”.

TABLE 1

| category | gender | age | Purchasing power |
|---|---|---|---|
| High rich | male | 20-30 | High |
| handsome | | | |

At 204, the server terminal may obtain feature information of the target user based on the search request and obtain a search result corresponding to the feature information and the search information such that the client terminal receives and displays the search result.

In implementations, the feature information of the target user may include but is not limited to one of property information of the target user, behavior information of the target user, or preference information of the target user.

In implementations, the feature information of the target user may include, but is not limited to, a gender, an age, a location, and other information of the target user. Behavioral information and/or preference information of the target user may be obtained based on historical behavior of the target user that is recorded in logs.

For example, after the server terminal receives the search request including the keyword, the search condition, and the target user, the server terminal may obtain the feature information of the target user based on the search request. Suppose that the feature information of the target user (e.g., personalized information of users) includes: female, 20-30 years old, ordinary purchasing power, a corresponding IP address (Internet Protocol Address) indicating Hainan province.

Suppose that the keyword is a woman's dress. The server terminal may perform searches based on the feature information of the target user and the keyword to obtain item information of the woman's dress fitting for a current time in Hainan province. The server terminal may return the item information to the client terminal. This allows users to easily obtain and to view personalized search results of the target user.

Implementations for obtaining search results may include receiving from a client terminal search information input by a current user on the client terminal and a search request including a target user that is associated with the search information and designated by the current user. Accordingly, the server terminal may obtain feature information of the target user based on the search request, obtain a search result corresponding to the feature information based on the search information, and return the search result to the client terminal to the client terminal such that the client terminal receives and displays the search result.

Implementations herein provide an approach for obtaining search results associated with a desired target user. This allows users to easily obtain personalized search results of other objects, to meet individual needs of the users, and to improve search experience of the users.

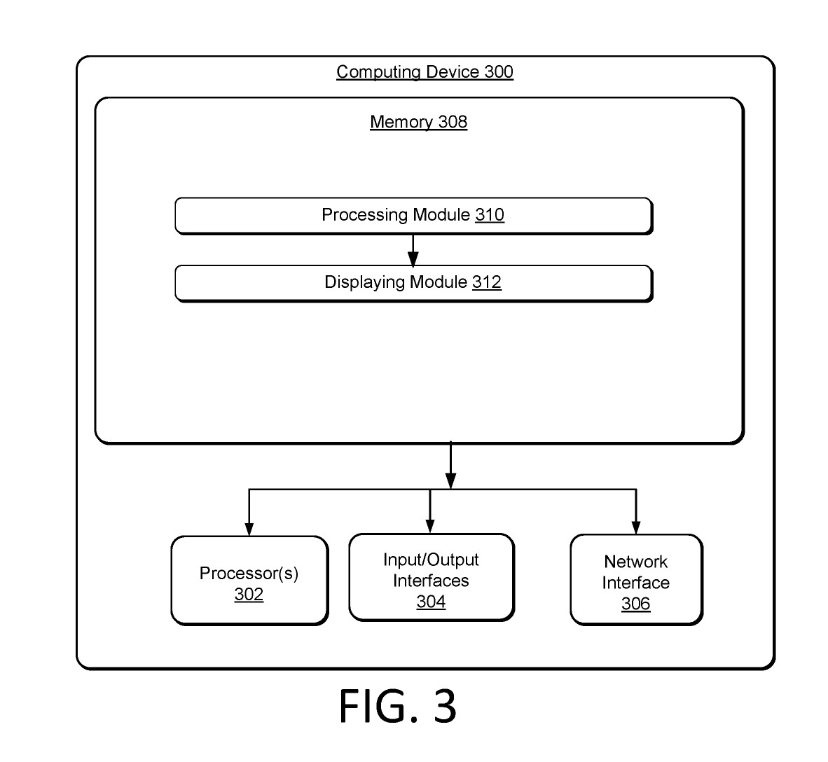

The implementations here further relate to systems/devices for obtaining search results. FIG. 3 is a diagram depicting an example device for obtaining search results in accordance with an embodiment of the present disclosure.

As illustrated in FIG. 3, the device is located on a terminal (e.g., a client terminal). In an exemplary configuration, the computing device 300 includes one or more processors 302, input/output interfaces 304, network interface 306, and memory 308.

The memory 308 may include computer-readable media in the form of volatile memory, such as random-access memory (RAM) and/or non-volatile memory, such as read only memory (ROM) or flash RAM. The memory 308 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 308 in more detail, the memory 308 may include a processing module 310 and a displaying module 312. The processing module 310 may be configured to receive search information input by a current user and a target user that is associated with the search information and designated by the current user. The processing module 310 may further transmit to a server terminal a search request including the search information and the target user such that the server terminal may obtain feature information of the target user based on the search request. The server terminal may further obtain a search result corresponding to the feature information based on the search information and return the search result to the client terminal. The displaying module 312 may be configured to receive and display the search result that is returned from the server terminal.

In implementations, the search information may include a keyword input by users and a search condition selected by the user (e.g., a type of a search object, release time intervals of the search object, etc.). The target user may be a target user or belong to a category of the target user. The feature information of the target user may include at least one of property information of the target user, behavior information of the target user, or preference information of the target user. Behavioral information and/or preference information of the target user may be obtained based on historical behavior of the target user that is recorded in logs.

In implementations, the feature information of the target user may include, but is not limited to, a gender, an age, a location, and other information of the target user. The terminal may include a smart phone, a tablet computer, a personal computer (PC) with a variety of operating systems and other hardware devices.

In implementations, the current user may use a search engine to perform searches. The current user may input a keyword and a search condition (e.g., a price range, a service type, a brand, etc.). If the current user does not want to use a current default identity with respect to a certain search, the current user may choose a desired identify for the certain search. The processing module 310 may receive a selection of the current user. Further, the client terminal may determine whether the desired identity (e.g., the target user) is another user (e.g., the target user) or another type of users. The client terminal may provide the corresponding processing strategy based on the determination.

In response to a determination that the target user selected by a current user associated with the client terminal for the search is the target user, the current user may set the desired identify (e.g., the target user) for the search using the following ways. Accordingly, the processing module 310 may perform appropriate processing operations in accordance with the implementations.

In implementations, if the current user uses the account ID and password to set up the desired identify of the target user, the processing module 310 may receive the account ID of the target user that is input by the current user. The client terminal may transmit to the server terminal a permission query such that the server terminal obtains a query permission of the current user from pre-stored user query permissions based on the permission query. If the query permission is a default permission, the server terminal may return a default command to a client terminal. Accordingly, the processing module 310 may receive the default command from the server terminal. Further, the client terminal may display the interface for inputting the password based on the received default command.

The processing module 310 may receive the password that is input by the current user into the interface and transmit to the server terminal the account ID and the password. Therefore, after the server terminal confirms that the password corresponds to the account ID, the server terminal may return a first instruction of successful acceptance of target user to the processing module 310, which may accept the target user based on the first instruction.

If the current user uses the account ID and password to set up the desired identify of the target user, the processing module 310 may receive the account ID of the target user that is input by the current user. The client terminal may transmit the account ID of the target user to the server terminal such that the server terminal may search and obtain a list of authorized users associated with the target user based on the account ID of the target user.

If the list of authorized users includes the account ID of the current user, the server terminal may return a second instruction of successful acceptance of target user. Then, the processing module 310 may accept the target user based on the second instruction.

In implementations, when the target user of a current search belongs to the category of the target user, the processing module 310 may transmit to the server terminal a category search request of the current user such that the server terminal may obtain a pre-stored category list of different categories of users based on the category search request. Further, the server terminal may return to the client terminal the category list.

The displaying module 312 may be configured to receive the category list from the client terminal and display the category list on the current interface. After displaying the category list on the current interface, the processing module 310 may receive a category of the target user that is selected by the current user from a category list of different users that is displayed by a current interface.

Implementations of the device including the processing module 310 and the displaying module 312 may include the operations as illustrated in FIG. 1.

The device may receive search information input by a current user and a target user that is associated with the search information and designated by the current user via the processing module 310, transmit to a server terminal a search request including the search information and the target user such that the server terminal may obtain feature information of the target user based on the search request, obtain a search result corresponding to the feature information based on the search information, and return the search result to the client terminal. Then, the displaying module 312 may receive and display the search result returned from the server terminal.

Accordingly, the implementations provide an approach for obtaining search results associated with a desired target user. This allows users to easily obtain personalized search results of other objects, to meet individual needs of the users, and to improve search experience of the users.

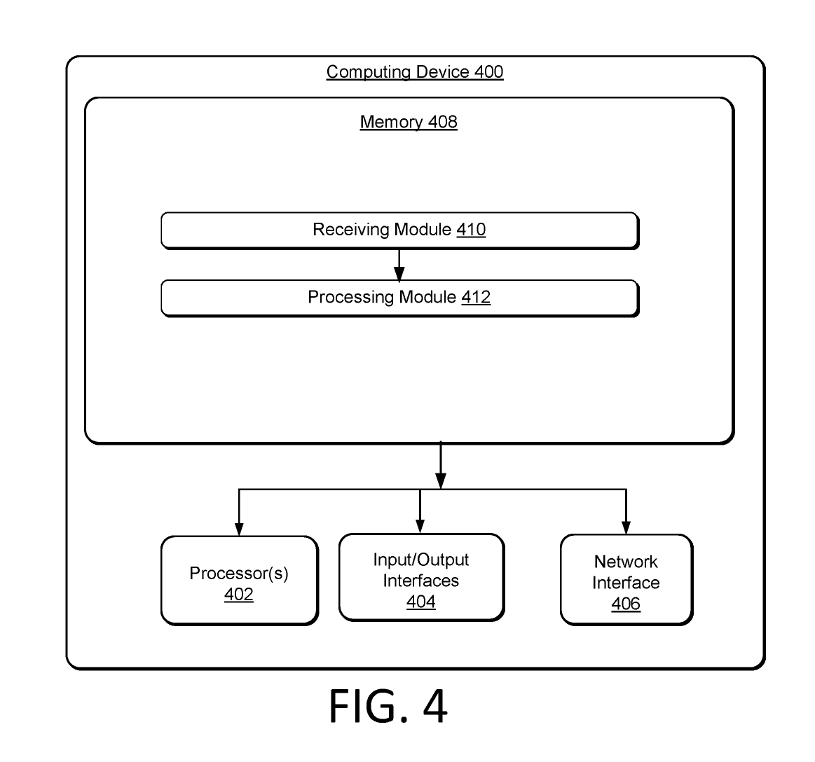

The implementations here further relate to systems/devices for obtaining search results. FIG. 4 is a diagram depicting another example device for obtaining search results in accordance with an embodiment of the present disclosure.

As illustrated in FIG. 4, the device is located on a server terminal. In one exemplary configuration, the computing device 400 includes one or more processors 402, input/output interfaces 404, network interface 406, and memory 408.

The memory 408 may include computer-readable media in the form of volatile memory, such as random-access memory (RAM) and/or non-volatile memory, such as read only memory (ROM) or flash RAM. The memory 408 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 408 in more detail, the memory 408 may include a receiving module 410 and a processing module 412. The receiving module 410 may be configured to receive a search request from a client terminal. In these instances, the search request may include search information input by a current user and a target user that is associated with the search information and designated by the current user.

The processing module 412 may be configured to obtain feature information of the target user based on the search request, obtain a search result corresponding to the feature information based on the search information, and return the search result to the client terminal such that the client terminal may receive and display the search result.

In implementations, the search information may include a keyword input by users and a search condition selected by the user (e.g., a type of a search object, release time intervals of the search object, etc.). The target user may be a target user or belong to a category of the target user. The feature information of the target user may include at least one of property information of the target user, behavior information of the target user, or preference information of the target user.

In implementations, the feature information of the target user may include, but is not limited to, a gender, an age, a location, and other information of the target user. Behavioral information and/or preference information of the target user may be obtained based on historical behavior of the target user that is recorded in logs.

In implementations, the desired identity (e.g., the target user) selected by a current user associated with the client terminal is the target user for the search. In these instances, the current user may use the account ID and password to set up the desired identify of the target user. Before receiving a search request by the receiving module 410, the processing module 412 may further receive from the client terminal the account ID of the target user and a password associated with the account ID. In response to a determination that the password is correct, the processing module 412 may return to the client terminal a first instruction of successful acceptance of the target user to allow the client terminal to accept the target user based on the second instruction.

In implementations, before the processing module 412 receives from the client terminal the account ID of the target user and the password associated with the account ID, the processing module 412 may further receive from the client terminal a permission query and obtain a query permission of the current user from pre-stored user query permissions based on the permission query. If the query permission is a default permission, the server terminal may return a default command to a client terminal such that the client terminal display the interface for inputting the password based on the received default command.

In implementations, the target user selected by a current user associated with the client terminal is the target user for the search and the current user may set the target user for the search using an authorization mode. In these instances, before receiving a search request by the receiving module 410, the processing module 412 may further receive from the client terminal the account ID of the target user and a password associated with the account ID such that the server terminal may search a list of authorized users associated with the target user based on the account ID of the target user. If the list of authorized users includes the account ID of the current user, the server terminal may return a second instruction of successful acceptance of target user to allow the client terminal to accept the target user based on the second instruction.

In some implementations, the target user of a current search selected by the current user associated with the client terminal belongs to the category of the target user. In these instances, before receiving a search request by the receiving module 410, the processing module 412 may further obtain a category list of different categories of users based on historic records. The server terminal may return to the client terminal the category list to allow the client terminal to display the category list and to allow the current user to select the category of the target user from the category list of different users.

Implementations of the device including the receiving module 410 and the processing module 412 may include the operations as illustrated in FIG. 2.

The device, via the receiving module 410, may receive from a client terminal search information input by a current user on the client terminal and a search request including a target user that is associated with the search information and designated by the current user. The processing module 412 may obtain feature information of the target user based on the search request, obtain a search result corresponding to the feature information based on the search information, and return the search result to the client terminal such that the client terminal receives and displays the search result.

Accordingly, the implementations provide an approach for obtaining search results associated with a desired target user. This allows users to easily obtain personalized search results of other objects, to meet individual needs of the users, and to improve search experience of the users.

Reference throughout this specification to “one implementation,” “an implementation,” “one example,” or “an example” means that a particular feature, structure, or characteristic described in connection with the implementation or example is included in at least one implementation of the present disclosure. Thus, appearances of the phrases “in one implementation,” “in an implementation,” “one example,” or “an example” in various places throughout this specification are not necessarily all referring to the same implementation or example. Furthermore, the particular features, structures, databases, or characteristics may be combined in any suitable combinations and/or sub-combinations in one or more implementations or examples.

Furthermore, the term “first”, “second” for descriptive purposes only, and not be interpreted as numbers of technical features that indicate or imply relatively important. Thus, the “first” feature or “second” feature may include at least one of the features as described in the present disclosure; “a plurality” means at least two unless explicitly specified otherwise.

The flowchart in any process or method or otherwise described in this description may be understood to indicate that one or more steps for implementing specific logical functions or processing executable instruction codes, modules, segments, or portions thereof. The scope of a preferred implementations of the present disclosure includes further implementations, which may not be shown or discussed in a certain order and may be performed in a substantially simultaneous manner or in a reverse order to achieve certain functions. This should be understood by those skilled in the art.

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which may include one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. For example, any one of the following techniques or their combination may be implemented: a data signal for implementing logic functions of logic gates discrete logic circuit having appropriate combinational logic gates of ASIC, programmable gate array (PGA), a field programmable gate array (FPGA) and the like. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks. Generally, computer-executable instructions include routines, programs, objects, components, data structures, and the like that perform particular functions or implement particular abstract data types. Computer-readable media includes volatile and non-volatile, removable and non-removable media implemented in any method or technology for storage of information such as computer readable instructions, data structures, program modules, or other data.

Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

It should be appreciated that the various parts of the present invention may be implemented in hardware, software, firmware, or a combination thereof. In the above-described embodiment, a plurality of steps or methods may be performed by the system and the software stored in the memory or executed by a suitable instruction firmware to achieve, for example, if implemented in hardware, any one of the following techniques well known in the art or their combination to achieve the implementations as described above: discrete logic circuitry of logic gate circuits for implementing logic functions on the data signal, a suitable combination of logic gate circuit ASIC, programmable gate array (PGA), a field programmable gate array (FPGA) and the like.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A method for obtaining search results, the method comprising:
receiving, by one or more processors of a computing device, search information provided by a user and target user information that is associated with the search information and designated by the user;
transmitting, by the one or more processors, to a server terminal a search request comprising the search information and the target user information such that the server terminal:
obtains feature information of the target user based on the search request;
obtains a search result corresponding to the feature information and the search information; and
returns the search result; and
receiving and displaying, by the one or more processors, the search result returned from the server terminal.

2. The method of claim 1, wherein the search information comprises a key word and a search condition, the target user information comprises a target user ID or a category of the target user, and the feature information of the target user comprises at least one of property information of the target user, behavior information of the target user, or preference information of the target user.

3. The method of claim 2, wherein:
the receiving the search information provided by the user and the target user information that is associated with the search information and designated by the user comprises:
receiving an account ID of the target user that is input by the user;
displaying an interface for inputting a password;
receiving the password that is input by the user into the interface;
transmitting to the server terminal the account ID and the password such that the server terminal returns a first instruction of successful acceptance of target user after the server terminal confirms that the password corresponds to the account ID, and
accepting the target user based on the first instruction.

4. The method of claim 2, wherein:
the receiving the search information provided by the user and the target user information that is associated with the search information and designated by the user comprises:
receiving the account ID of the target user that is input by the user,
transmitting to the server terminal the account ID of the target user such that the server terminal:
searches a list of authorized users associated with the target user based on the account ID of the target user, and
returns a second instruction of successful acceptance of target user if the list of authorized users comprises the account ID of the user, and accepting the target user based on the second instruction.

5. The method of claim 3, wherein the displaying the interface for inputting the password comprises:
transmitting to the server terminal a permission query such that the server terminal:
obtains a query permission of the user from pre-stored user query permissions based on the permission query, and
returns a default command to a client terminal if the query permission is a default permission; and
displaying the interface for inputting the password based on the default command.

6. The method of claim 2, wherein the target user belongs to the category of the target user, and wherein the receiving the target user information that is associated with the search information and designated by the user comprises receiving a category of the target user that is selected by the user from a category list of different users that is displayed by an interface.

7. The method of claim 6, further comprising:
prior to the receiving the category of the target user that is selected by the user from the category list of the different users that is displayed by the interface,
receiving from the server terminal the category list; and
displaying the category list.

8. A method for obtaining search results, the method comprising:
receiving, by one or more processors of a computing device, a search request from a client terminal, the search request comprising search information input by a user and target user information that is associated with the search information and designated by the user;
obtaining, by the one or more processors, feature information of the target user based on the search request;
obtaining, by the one or more processors, a search result corresponding to the feature information and the search information; and
returning, by the one or more processors, the search result such that the client terminal receives and displays the search result.

9. The method of claim 8, wherein the search information comprises a key word and a search condition, the target user comprises a target user or a category of the target user, and the feature information of the target user comprises at least one of property information of the target user, behavior information of the target user, or preference information of the target user.

10. The method of claim 8, further comprising:
receiving from the client terminal an account ID of the target user and a password associated with the account ID prior to the receiving the search request from the client terminal, and
returning to the client terminal a first instruction of successful acceptance of the target user such that the client terminal accepts the target user based on the first instruction in response to a determination that the password is correct; or
receiving from the client terminal the account ID of the target user to:
search a list of authorized users associated with the target user based on the account ID of the target user, and
return to the client terminal a second instruction of successful acceptance of the target user to allow the client terminal to accept the target user based on the second instruction if the list of authorized users comprises the account ID of the user.

11. The method of claim 8, wherein the target user information is a category of the target user, further comprising:
prior to the receiving the search request from the client terminal,
obtaining a category list of different categories of users based on historic records; and
returning to the client terminal the category list to allow the client terminal to display the category list and to allow the user to select the category of the target user from a category list of different users.

12. The method of claim 8, further comprising:
prior to the receiving from the client an account ID of the target user and a password associated with the account ID,
receiving from the client terminal a permission query such as to obtain a query permission of the user from pre-stored user query permissions based on the permission query; and
returning a default command to the client terminal if the query permission is a default permission.

13. A device for obtaining search results, the device comprising:
one or more processors; and
memory to maintain a plurality of components executable by the one or more processors, the plurality of components comprising:
a processing module configured to:
receive search information input by a user and target user information that is associated with the search information and designated by the user, and
transmit to a server terminal a search request comprising the search information and the target user information such that the server terminal:
obtains feature information of the target user based on the search request,
obtains a search result corresponding to the feature information and the search information, and
returns the search result, and
a displaying module configured to receive and display the search result returned from the server terminal.

14. The device of claim 13, wherein the search information comprises a key word and a search condition.

15. The device of claim 13, wherein the feature information of the target user comprises at least one of property information of the target user, behavior information of the target user, or preference information of the target user.

16. The device of claim 13, wherein the target user comprises a target user or a category of the target user.

17. The device of claim 16, wherein the target user belongs to the category of the target user, and wherein the processing module is configured to further:
receive an account ID of the target user that is input by the user,
display an interface for inputting a password,
receive the password that is input by the user into the interface,
transmit to the server terminal the account ID and the password such that the server terminal returns to a client terminal a first instruction of successful acceptance of the target user after the server terminal confirms that the password corresponds to the account ID, and
accept the target user based on the first instruction; or
receive the account ID of the target user that is input by the user if the target user belongs to the category of the target user;
transmit to the server terminal the account ID of the target user such that the server terminal:
searches a list of authorized users associated with the target user based on the account ID of the target user, and
returns a second instruction of successful acceptance of target user if the list of authorized users comprises the account ID of the user, and
accept the target user based on the second instruction.

18. The device of claim 17, wherein the processing module is configured to further:
transmit to the server terminal a permission query such that the server terminal:
obtains a query permission of the user from pre-stored user query permissions based on the permission query, and
returns a default command to a client terminal if the query permission is a default permission; and
display the interface for inputting the password based on the default command.

19. The device of claim 16, wherein the target user belongs to the category of the target user, and wherein the processing module is configured to further:
receive the category of the target user that is selected by the user from a category list of different users that is displayed by an interface.

20. The device of claim 19, wherein the display module is configured to further:
prior to the receiving the category of the target user that is selected by the user from the category list of the different users that is displayed by an interface,
receive from the server terminal the category list; and
display the category list.
